(19) United States
(12) Patent Application Publication
(10) Pub. No.: US 2008/0127860 A1
(43) Pub. Date: Jun. 5, 2008

(54) Use of Bismuth Vanadate Pigments Containing Aluminium For Colouring Coating Powder

(75) Inventors: Kirill Bramnik, Mannheim (DE); Eckhard Korona, Neustadt (DE); Norbert Mronga, Dossenheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/814,589

(22) PCT Filed: Jan. 23, 2006
(86) PCT No.: PCT/EP06/50377

§ 371 Date: Jul. 24, 2007

(30) Foreign Application Priority Data
Jan. 26, 2005 (DE) 10 2005 003717.8

(51) Int. Cl. C09C 1/64

(52) U.S. Cl. 106/404

(57) ABSTRACT

The use of bismuth vanadate pigments containing ≧1.4% by weight of aluminum for coloring powder coating materials.

The present invention relates to the use of bismuth vanadate pigments containing ≧1.4% by weight of aluminum for coloring powder coating materials.

The invention further relates to powder coating materials and powder coatings comprising these bismuth vanadate pigments as a coloring component.

The invention relates not least to new bismuth vanadate pigments which have been provided with a coating comprising sparingly soluble aluminum compounds and calcium compounds and has an aluminum content of ≧1.4% by weight, based on the total pigment.

Bismuth vanadate pigments have been known for a long time and are used in particular for coloring coating materials and plastics. Besides the pure BiVO₄ pigment, which may be present in monoclinic or tetragonal crystal polymorph, a series of BiVO₄ pigments is described in which some of the metal atoms and/or oxygen atoms have been replaced by other metals and/or nonmetals. To enhance their performance properties, particularly their thermal stability, weatherfastness and chemical resistance, the bismuth vanadate pigments are often provided with protective casings of metal phosphates, but also with protective casings of metal oxides and/or metal fluorides, which are produced by precipitating the phosphates, oxides or hydroxides, and fluorides from preferably aqueous solutions of soluble salts of the corresponding metals. Examples of compounds used with particular frequency for the stabilizing coatings are the phosphates of calcium, zinc and aluminum, and mixtures thereof, and also the oxides of aluminum and silicon.

The coating of bismuth vanadate pigments with stabilizing aluminum compounds is described in a series of documents.

Thus U.S. Pat. No. 5,123,965 discloses the coating with aluminum phosphate or with a mixture of aluminum phosphate and zinc phosphate for the purpose of providing stabilization against the attack of hydrochloric acid. Additionally, stabilization with aluminum phosphate or aluminum oxide is described in U.S. Pat. No. 4,115,141.

In U.S. Pat. No. 4,752,460, doped tetragonal bismuth vanadate pigments are coated with silicon dioxide and aluminum oxide in order to increase their stability in general. The stabilization of phosphate-containing monoclinic bismuth vanadate pigments by successive coating with aluminum hydroxide and calcium phosphate is known from EP-A-551 637. In U.S. Pat. No. 4,063,956, thermal stability and acid resistance of monoclinic bismuth vanadate pigments are increased by coating with water-containing metal oxides, such as aluminum oxide, and a subsequent dense silicon dioxide layer.

Finally, EP-A-723 998 discloses a multiple coating of bismuth vanadate pigments, activated first with sodium phosphate, for the purpose of increasing their thermal stability, where silicon dioxide, aluminum oxide, aluminum phosphate and/or zinc phosphate and, if appropriate, dimethylpolysiloxane are combined as coating materials.

Bismuth vanadate pigments which comprise aluminum in the core pigment structure, i.e., have been doped with aluminum, are known from U.S. Pat. Nos. 4,026,722 and 4,230,500, according to which they are prepared by jointly heat-treating aluminum oxide and bismuth oxide and ammonium vanadate or by solid-state synthesis from the phosphates. Moreover, EP-A-640 566 describes bismuth vanadate pigments which have been doped with combinations of different metals and which may also comprise phosphate as a partial replacement for vanadate, these pigments being prepared by wet-chemical precipitation. Aluminum is among the doping metals specified.

Finally, EP-A-1 072 656 discloses mixtures of bismuth vanadate pigments with phosphates, including aluminum phosphate, which are prepared by conjoint wet grinding. The addition of phosphate raises the shelf life of coating materials pigmented with bismuth vanadate; in other words, the increase in viscosity which normally occurs over time is markedly reduced.

None of these publications concerns the use of bismuth vanadate pigments in powder coating materials. Powder coating materials have to date been baked at temperatures of up to 190° C. in a few minutes on the surfaces to be coated. The baking conditions, however, are becoming increasingly harsher, so that now overbake temperatures of >190° C. are among those used. At such temperatures the bismuth vanadate pigments available on the market not only turn green but also impair the coating-material properties. Accordingly the coating becomes brittle, exhibits craters, and adheres poorly to the surface to be coated.

It was an object of the invention, therefore, to remedy these deficiencies and to provide bismuth vanadate pigments for coloring powder coating materials.

Found accordingly has been the use of bismuth vanadate pigments containing ≧1.4% by weight of aluminum for coloring powder coating materials.

When bismuth vanadate pigments of this kind are used in powder coating materials, surprisingly, neither greening nor any of the further forms of coating impairment described above is observed.

In general the bismuth vanadate pigments for use in accordance with the invention comprise 1.4% to 10% by weight, preferably 1.5% to 7% by weight, more preferably 1.5% to 5% by weight, of aluminum.

The bismuth vanadate pigments may have been provided with a coating comprising sparingly soluble aluminum compounds, may have been doped with aluminum, or may be in the form of a mixture with sparingly soluble aluminum compounds.

It will be appreciated that any combination of these measures is also possible.

Thus, for example, coating with sparingly soluble aluminum compounds may be combined with aluminum doping of the core pigment structure. In this case, which constitutes a preferred embodiment of the invention, the sum of the aluminium comprised in the pigment and on the pigment is ≧1.4% by weight; in other words, the coating need not alone comprise the required amount of aluminum.

Another preferred embodiment constitutes the use of bismuth vanadates which comprise aluminum exclusively in the coating.

In this case, as also in the case of all other versions, the bismuth vanadate pigment may be in the tetragonal crystal polymorph or in the preferred monoclinic crystal polymorph, and may be in any known doping form. By way of example reference may be made to the pigments described in the following publications: EP-A-074 049, 239 526, 430 888, 492 244, 551 637, 640 566, 758 670 and 984 044, and also WO-A-92/11205.

Sparingly soluble aluminum compounds suitable for the coating are, in particular, aluminum phosphates, especially aluminum orthophosphate AlPO₄ and phosphates comprising hydroxide and/or halide ions, such as Al₂PO₄(OH)₃ and Al₃(PO₄)₂(OH,F)₃, aluminum oxides, especially Al₂O₃ and water-containing aluminum oxides such as AlOOH and Al(OH)₃, aluminosilicates, hydrotalcite, and AlF₃. Preference is given to aluminum phosphates and aluminum oxides, AlOOH being particularly preferred.

The coating with sparingly soluble aluminum compounds can always also be combined with the coating with further sparingly soluble metal compounds whose use for stabilizing bismuth vanadate pigments is known. In that case the aluminum compounds and the further metal compounds may be in one layer, including a mixed salt form, for example, or may be applied as successive layers.

Examples of sparingly soluble metal compounds are metal phosphates, especially phosphates of alkaline-earth metals, such as magnesium, calcium and strontium, zinc and rare earths, such as cerium, with calcium phosphates being preferred, and sparingly soluble metal oxides, such as silicon dioxide, zirconium dioxide and cerium oxide.

It will be appreciated that mixtures of these compounds and also mixed phosphates such as (Ca,Zn)₃(PO₄)₂ can also be used.

The bismuth vanadate pigments for use in accordance with the invention, coated with sparingly soluble aluminum compounds, are customarily prepared by precipitation reaction, by intensively mixing with one another a preferably aqueous suspension of the substrate pigment, which may be uncoated or already coated with a stabilizing layer, and a solution of an aluminum salt, aluminum nitrate or aluminum sulfate for example, and maintaining the mixture at a pH which is suitable for the precipitation of the sparingly soluble aluminum compound and is usually from 3 to 10, in particular from 5 to 8, the presence of a phosphate source, phosphoric acid, for example, being mandatory in order to deposit an aluminum phosphate. In parallel with this it is possible to deposit other sparingly soluble metal compounds, examples being calcium phosphates or calcium/zinc phosphates. Also possible is a subsequent coating with sparingly soluble metal compounds.

For preparing the aluminum-doped bismuth vanadate pigments for use in accordance with the invention it is possible to add soluble aluminum salts during the wet-chemical process prior to pigment precipitation, in a mixture, for example, with the bismuth(III) salt solutions serving as reactant, or after the mixing of bismuth and vanadium reactants, prior to the recrystallization. It will be appreciated that the aluminum salts can also be used in combination with the soluble salts of other doping metals. In this context it is possible to employ all known precipitation processes.

A further possibility is the preparation of aluminum-doped bismuth vanadate pigments by the firing process from solid starting materials. In this case, bismuth, vanadium and aluminum reactants, e.g., bismuth oxide, vanadium oxide and aluminum hydroxide (plus, if desired, the reactants of further doping metals), can be calcined jointly after intensive mixing. It is, however, also possible to calcine a ready-prepared bismuth vanadate pigment with the aluminum reactant.

The mixtures of bismuth vanadate pigments with the abovementioned sparingly soluble aluminum compounds, which constitute a further embodiment of the present invention, can be obtained, finally and preferably, by conjoint grinding, in particular by wet grinding.

The powder coating materials likewise in accordance with the invention comprise customarily 1% to 50% by weight of the bismuth vanadate pigment as a coloring component.

The powder coating materials can be used with advantage for coating any substrate material, i.e., both metallic and nonmetallic materials, and also all other conceivable materials.

The coatings obtained are distinguished by their homogeneous appearance. They are not brittle, exhibit no textured surface (craters), and adhere firmly to the substrate to be coated.

### EXAMPLES

### Preparation and Testing of Inventive Bismuth Vanadate Pigments

To test the thermal stability of the bismuth vanadate pigments obtained, powder coating materials on a polyester/hydroxyalkylamide basis were produced in a green RAL shade, applied to aluminum panels, and then subjected to coloristic measurement.

For this purpose 25 g of the respective bismuth vanadate pigment were mixed thoroughly with 888.7 g of polyester resin (Uralac® P800; DSM Resins), 37 g of hydroxyalkylamide (Primid® XL 552, EMS-Primid), 9 g of flow assistant (BYK 365 P; Byk Chemie, Wesel), 2 g of devolatilizer (Benzoin), 16.7 g of C.I. Pigment Yellow 53 (Sicotane Yellow L1010; BASF Aktiengesellschaft), 20 g of C.I. Pigment Brown 24 (Sicotan Yellow L2110) and 1.6 g of C.I. Pigment Green 7 (Heliogene Green L8731; BASF Aktiengesellschaft) for 3 minutes in a laboratory mixer (MIXACO Dr. Herfeld GmbH & Co. KG) at 1000 rpm with water cooling.

The finished mixture was subsequently processed in an extruder with a rotary speed of 100 rpm. The temperature of the compound at the outlet was approximately 110° C. The plasticified compound was passed through two chill rolls, where it was rolled and cooled to room temperature. The rolled sheet produced was prefractionated by hand and then ground in a laboratory mill (IKA Labortechnik GmbH). The contents of the mill were fed to a 150 μm sieve and sieved off on a shaker (Retsch GmbH & Co. KG) in approximately 1 h.

The powder coating material was applied to small aluminum panels using a corona powder gun with a voltage of approximately 80 kV. After being coated, the panels were baked at 210° C. in a preheated forced-air oven for 60 minutes.

Coloristic measurement of the coated panels took place in each case in comparison with a panel coated with the same powder coating material and baked at 180° C. for 15 minutes (determination of deviation in the CIELAB color values of hue angle H (dH), chroma C* (dC*) and lightness L* (dL*), and also in the overall coloristics (dL*), using a Spectrolino (Gretag-Macbeth) spectrophotometer.

In addition the surface of the coatings (leveling, structure, and cratering) was assessed visually.

The results obtained are compiled in the table which follows below.

### Example 1

First of all a core bismuth vanadate structure was prepared by the method of example 9 of EP-A-984 044, but with the additional addition of 3.8 g of aluminum nitrate (Al(NO₃)₃×9H₂O) prior to heating.

57 g of the core bismuth vanadate structure obtained in this way were converted into a 14.3% by weight suspension, by being stirred into water, and this suspension was then heated to 80° C. At a pH of 6.5, which was maintained by adding 5% strength by weight sodium hydroxide solution, 128.6 g of a 15.3% strength by weight solution of aluminum nitrate (Al(NO₃)₃×9H₂O) were pumped in. After 15 minutes of subsequent stirring 202.6 g of a solution of calcium nitrate and zinc nitrate (5.2% by weight Ca(NO₃)₂×4H₂O; 7.6% by weight Zn(NO₃)₂×6H₂O) were metered in parallel with 208.6 g of a 4.5% strength by weight phosphoric acid, the pH being maintained at 6.5 by the addition of further 5% strength by weight sodium hydroxide solution.

After subsequent stirring at 20° C. for one hour the coated pigment was isolated by filtration, washed with water, and dried at 110° C. overnight in a forced-air drying cabinet.

The coating operation was subsequently repeated once again.

The resulting pigment comprised 2.1% by weight of aluminum.

### Example 2

80 g of a core bismuth vanadate structure prepared as in example 1 were converted into a 14.3% by weight suspension, by being stirred into water, and this suspension was then heated to 80° C. At a pH of 6.5, which was maintained by adding 5% strength by weight sodium hydroxide solution, 361.2 g of the 15.3% strength by weight solution of aluminum nitrate used in example 1 were pumped in. After 15 minutes of subsequent stirring 568.6 g of the solution of calcium nitrate and zinc nitrate used in example 1 were metered in parallel with 585.4 g of a 4.5% strength by weight phosphoric acid, the pH being maintained at 6.5 by the addition of further 5% strength by weight sodium hydroxide solution.

After subsequent stirring at 20° C. for one hour the coated pigment was isolated by filtration, washed with water, and dried at 110° C. overnight in a forced-air drying cabinet.

The resulting pigment comprised 3.4% by weight of aluminum.

### Example 3

80 g of a core bismuth vanadate structure prepared as in example 1 were converted into a 14.3% by weight suspension, by being stirred into water, and this suspension was then heated to 80° C. At a pH of 6.5, which was maintained by adding 5% strength by weight sodium hydroxide solution, 180.6 g of the 15.3% strength by weight solution of aluminum nitrate used in example 1 were pumped in. After 15 minutes of subsequent stirring a solution of 21.6 g of zinc nitrate (Zn(NO₃)₂×6H₂O) in 284 g of water was metered in parallel with 288.4 g of a 2.5% strength by weight phosphoric acid, the pH being maintained at 6.5 by the addition of further 5% strength by weight sodium hydroxide solution.

After subsequent stirring at 20° C. for one hour the coated pigment was isolated by filtration, washed with water, and dried at 110° C. overnight in a forced-air drying cabinet.

The resulting pigment comprised 2.3% by weight of aluminum.

### Example 4

80 g of a core bismuth vanadate structure prepared as in example 1 were converted into a 14.3% by weight suspension, by being stirred into water, and this suspension was then heated to 80° C. At a pH of 6.5, which was maintained by adding 5% strength by weight sodium hydroxide solution, 180.6 g of the 15.3% strength by weight solution of aluminum nitrate used in example 1 were pumped in. After 15 minutes of subsequent stirring a solution of 15.1 g of zinc nitrate (Zn(NO₃)₂×6H₂O) in 284 g of water was metered in parallel with 287.2 g of a 2.2% strength by weight phosphoric acid, the pH being maintained at 6.5 by the addition of further 5% strength by weight sodium hydroxide solution.

After subsequent stirring at 20° C. for one hour the coated pigment was isolated by filtration, washed with water, and dried at 110° C. overnight in a forced-air drying cabinet.

The resulting pigment comprised 2.4% by weight of aluminum.

### Example 5

First of all a core bismuth vanadate structure was prepared by the method of example 1, but additionally with the substitution of 10 mol % of bismuth vanadate by aluminum nitrate.

57 g of the core bismuth vanadate structure obtained in this way were converted into a 14.3% by weight suspension, by being stirred into water, and this suspension was then heated to 80° C. At a pH of 6.5, which was maintained by adding 5% strength by weight sodium hydroxide solution, 64.3 g of the 15.3% strength by weight solution of aluminum nitrate used in example 1 were pumped in. After 15 minutes of subsequent stirring 101.3 g of the solution of calcium nitrate and zinc nitrate used in example 1 were metered in parallel with 104.3 g of a 4.5% strength by weight phosphoric acid, the pH being maintained at 6.5 by the addition of further 5% strength by weight sodium hydroxide solution.

After subsequent stirring at 20° C. for one hour the coated pigment was isolated by filtration, washed with water, and dried at 110° C. overnight in a forced-air drying cabinet. The resulting pigment comprised 2.0% by weight of aluminum.

### Example 6

80 g of a core bismuth vanadate structure prepared as in example 1 were calcined at 550° C. for 30 minutes and then converted into a 14.3% by weight suspension, by being stirred into water, this suspension then being heated to 80° C. At a pH of 6.5, which was maintained by adding 5% strength by weight sodium hydroxide solution, 180.6 g of the 15.3% strength by weight aluminum nitrate solution used in example 1 were pumped in.

After subsequent stirring at 20° C. for one hour the coated pigment was isolated by filtration, washed with water and dried at 110° C. overnight in a forced-air drying cabinet. The resulting pigment comprised 2.6% by weight of aluminum.

### Example 7

In accordance with example 10 of EP-A-551 637, 80 g of a core bismuth vanadate structure were prepared and, after having been calcined at 550° C. for 30 minutes, were converted into a 14.3% strength by weight suspension, by being stirred into water, this suspension then being heated to 80° C. At a pH of 6.5, which was maintained by adding 5% strength by weight sodium hydroxide solution, 180.6 g of the 15.3% strength by weight aluminum nitrate solution used in example 1 were pumped in.

After subsequent stirring at 20° C. for one hour the coated pigment was isolated by filtration, washed with water and dried at 110° C. overnight in a forced-air drying cabinet.

The resulting pigment comprised 2.4% by weight of aluminum.

### COMPARATIVE EXAMPLE

For comparison purposes a bismuth vanadate pigment was prepared and stabilized in accordance with example 10 of EP-A-551 637.

The resulting pigment comprised 1.0% by weight of aluminum.

TABLE

| Pigment | | | | | | |
|---|---|---|---|---|---|---|
| from | | | | | Level- | |
| Ex. | dH | dC* | dL* | dE | ing | Surface texture |
| 1 | −1.5 | −2.5 | −1.0 | 3.1 | good | homogeneously smooth |
| 2 | −1.1 | −3.3 | −1.3 | 3.7 | good | homogeneously smooth |
| 3 | −2.3 | −4.2 | −2.2 | 5.2 | good | homogeneously smooth |
| 4 | −1.7 | −3.0 | −0.9 | 3.5 | good | homogeneously smooth |
| 5 | −1.3 | −3.2 | −0.9 | 3.6 | good | homogeneously smooth |
| 6 | −2.0 | −3.2 | −1.5 | 4.1 | good | homogeneously smooth |
| 7 | −2.2 | −2.6 | −1.2 | 3.6 | good | homogeneously smooth |
| C | >7 | >7 | >7 | >10 | poor | craters |

1-6. (canceled)

7. A pigment for coloring a powder coating material comprising bismuth vanadate containing ≧1.4% by weight of aluminum.

8. The pigment according to claim 7, wherein the bismuth vanadate pigment has been provided with a coating comprising a sparingly soluble aluminum compound and/or has been doped with aluminum and/or is in the form of a mixture with a sparingly soluble aluminum compound.

9. The pigment according to claim 7, wherein the bismuth vanadate pigment has been provided with a coating comprising a sparingly soluble aluminum compound and, optionally, a sparingly soluble metal compound.

10. The pigment according to claim 8, wherein the bismuth vanadate pigment has been provided with a coating comprising a sparingly soluble aluminum compound and, optionally, a sparingly soluble metal compound.

11. The pigment according to claim 7, wherein the bismuth vanadate pigment has been doped with aluminum and has been provided with a coating comprising a sparingly soluble aluminum compound and, optionally, a sparingly soluble metal compound.

12. The pigment according to claim 8, wherein the bismuth vanadate pigment has been doped with aluminum and has been provided with a coating comprising a sparingly soluble aluminum compound and, optionally, a sparingly soluble metal compound.

13. A powder coating material comprising as a coloring component the bismuth vanadate pigment according to claim 7.

14. A powder coating comprising the bismuth vanadate pigment according to claim 7.
